(19) United States
(12) Patent Application Publication
(10) Pub. No.: US 2026/0283899 A1
(43) Pub. Date: Sep. 24, 2026

(54) VOCALIZATION CONDITIONING METHOD AND VOCALIZATION TRAINING METHOD BY ORAL CAVITY APPROACH

(71) Applicant: Office RENKA CO., LTD., Osaka (JP)

(72) Inventor: Ayami AKAI, Osaka (JP)

(73) Assignee: Office RENKA CO., LTD., Osaka (JP)

(21) Appl. No.: 18/874,210

(22) PCT Filed: Aug. 25, 2023
(86) PCT No.: PCT/JP2023/030773

§ 371 Date: Dec. 12, 2024

(30) Foreign Application Priority Data
Aug. 30, 2022 (JP) 2022-137359

(51) Int. Cl. A61H 21/00; G09B 15/00

(52) U.S. Cl. CPC A61H 21/00; G09B 15/00

(57) ABSTRACT

A method includes a vocalization conditioning method by approaching an oral cavity. The method includes a first process of relaxing muscles included in a suprahyoid muscle group from the inside of the oral cavity and a second process of relaxing a base of a tongue from the inside of the oral cavity.

### TECHNICAL FIELD

The present disclosure relates to a vocalization conditioning method and a vocalization training method by accessing an oral cavity. This application claims priority on Japanese Patent Application No. 2022-137359 filed on Aug. 30, 2022, the entire content of which is incorporated herein by reference.

### BACKGROUND ART

PATENT LITERATURE 1 discloses an intra-oral massage tool. PATENT LITERATURE 1 merely discloses massaging an oral cavity, and does not disclose vocalization conditioning by accessing the oral cavity.

### CITATION LIST

### Patent Literature

PATENT LITERATURE 1: Japanese Laid-Open Patent Publication No. 2019-058353

### SUMMARY OF INVENTION

For musicians such as vocalists and other people who make a living using their voices, keeping their vocal organs in good condition is a very important issue. It would be of great benefit to the musicians and people who make a living using their voices if they can utilize a conditioning methodology for the oral cavity to solve voice problems or maintain better voices.

Therefore, a method for vocalization conditioning by accessing an oral cavity is desirable.

An aspect of the present disclosure is a vocalization conditioning method by accessing an oral cavity. The disclosed method includes a first process of relaxing muscles included in suprahyoid muscles from the inside of the oral cavity, and a second process of relaxing a base of a tongue from the inside of the oral cavity.

Another method of the present disclosure is a vocalization conditioning method by accessing an oral cavity. This method includes a first process of accessing a floor of the oral cavity, and a second process of accessing a base of a tongue. The first process includes repeating downward pressing on the floor of the oral cavity inside the oral cavity to repeatedly cause compression and release of compression with respect to the muscles included in the suprahyoid muscles. The second process includes at least one of: a 2-1 process of raising the base of the tongue with respect to the floor of the oral cavity by using an insertion body inserted between the bottom of the tongue and the floor of the oral cavity; and a 2-2 process of moving the tongue forward such that the base of the tongue presses the insertion body forward, with the insertion body inserted between the bottom of the tongue and the floor of the oral cavity.

Another aspect of the present disclosure is a vocal training method. The disclosed training method includes: performing the aforementioned vocalization conditioning method; and performing vocalization thereafter.

Further details will be provided in the subsequent description of embodiments.

### BRIEF DESCRIPTION OF DRAWINGS

FIG. 1 is a flowchart showing an example of a procedure of a vocalization conditioning method.

FIG. 2 illustrates a mylohyoid muscle.

FIG. 3 illustrates step S1.

FIG. 4 illustrates step S1.

FIG. 5 illustrates pressing a mandible in a first process (step S1).

FIG. 6 illustrates a 2-1 process.

FIG. 7 illustrates the 2-1 process.

FIG. 8 illustrates a 2-2 process.

FIG. 9 illustrates the inside of an oral cavity.

FIG. 10 is a table showing experimental results for group A.

FIG. 11 is a table showing experimental results for group B.

FIG. 12 illustrates a tongue when vowels are pronounced.

### DESCRIPTION OF EMBODIMENTS

### <1. Vocalization Conditioning Method and Vocal Training Method by Accessing Oral Cavity>

(1) A method according to an embodiment is a vocalization conditioning method by accessing an oral cavity, and the method may include a first process of relaxing muscles included in suprahyoid muscles from the inside of the oral cavity, and a second process of relaxing a base of a tongue from the inside of the oral cavity.

The “suprahyoid muscles” is a general term for a muscle group which includes mylohyoid, digastric, stylohyoid, and geniohyoid muscles. The suprahyoid muscles are located above the hyoid bone among hyoid muscles connected to the hyoid bone. The suprahyoid muscles form the floor of the oral cavity. The suprahyoid muscles connect the hyoid bone and the mandible, and are responsible for raising the hyoid bone and the floor of the oral cavity.

Therefore, by relaxing the muscles included in the suprahyoid muscles, the hyoid bone and the floor of the oral cavity become easier to be raised and lowered, thereby promoting smooth raising and lowering of the hyoid bone and the floor of the oral cavity. That is, the upper and lower movable range of the hyoid bone and the floor of the oral cavity is increased. The increased upper and lower movable range of the hyoid bone and the floor of the oral cavity enables the opening of the airway to be significantly changed. Relaxing the muscles included in the suprahyoid muscles can be achieved by, for example, stimulating the floor of the oral cavity. Since the tongue is supported by the floor of the oral cavity, when the floor of the oral cavity becomes easier to be raised and lowered, the tongue also becomes easier to be raised and lowered. In the first process, it is enough to relax at least one muscle included in the suprahyoid muscles.

The base of the tongue is the back side of the tongue. The base of the tongue is in a range roughly equal to ⅓ of the back side of the tongue. The base of the tongue is connected to the palatoglossal arch present in the back of the throat. By relaxing the base of the tongue, the muscle forming the palatoglossal arch is also relaxed, and the palatoglossal arch becomes easier to be stretched, thereby widening the airway. Relaxing the base of the tongue can be achieved by, for example, accessing the base of the tongue by using an insertion body inserted between the bottom of the tongue and the floor of the oral cavity. The insertion body relaxes the base of the tongue.

The hyoid bone and the floor of the oral cavity being easier to be raised and lowered have a positive influence on vocalization. Relaxing the suprahyoid muscles and the base of the tongue allows opening of the airway to be smoothly changed, and allows the airway to be easily opened wide, thereby obtaining improved vocalization. In addition, since the raising and lowering of the tongue also affect vocalization, when the floor of the oral cavity becomes easier to be raised and lowered and thereby the tongue supported by the floor of the oral cavity also becomes easier to be raised and lowered, improved vocalization can be achieved.

By relaxing the floor of the oral cavity and the base of the tongue, it is also expected that the superior pharyngeal constrictor muscle, which continues from the floor of the oral cavity and the base of the tongue backward, is relaxed. Relaxing the superior pharyngeal constrictor muscle allows the airway to be widened.

Here, “relaxing” refers to relaxing the muscles. Relaxing the muscles promotes smooth movement of the muscles. For example, the muscles can be relaxed by externally stimulating the muscles. Such a stimulation is applied to the muscles with the pressing body, for example. The pressing body may be a tool such as an oral cavity pressing tool, or may be a human finger (e.g., finger pad). It is also possible to relax the muscles by intentionally moving

(2) The method according to the embodiment is a vocalization conditioning method by accessing an oral cavity, and the method includes a first process of accessing a floor of the oral cavity, and a second process of accessing a base of a tongue.

The first process may include, as an access to the floor of the oral cavity, repeating downward pressing on the floor of the oral cavity inside the oral cavity to repeatedly cause compression and release of compression (or reduction in compression) with respect to muscles included in the suprahyoid muscles. It is possible to compress the suprahyoid muscles by pressing the floor of the oral cavity downward. The downward pressing is performed by, for example, applying a front end of a tool, such as an oral cavity pressing tool, inserted in the oral cavity, onto the floor of the oral cavity, and pressing the tool downward. The pressing is preferably performed with such a strength not to cause pain. By releasing or reducing the downward pressing, the compression is released or reduced. Releasing or reducing the downward pressing is, for example, upward movement of the tool. The oral cavity pressing tool preferably has a head provided at its front end, and a handle extending backward from the head. The head preferably has a shape imitating a human finger (e.g., finger pad). In this case, by grasping its handle and pressing down on the floor of the oral cavity, an access similar to pressing down on the floor of the oral cavity with a human finger can be achieved.

By repeating the downward pressing on the floor of the oral cavity, compression and release of compression with respect to the muscles included in the suprahyoid muscles are repeatedly generated, thereby effectively relaxing the floor of the oral cavity. Repeating the downward pressing is, for example, performing the up-and-down movement of the oral cavity pressing tool multiple times. Since the floor of the oral cavity has a certain spread, in order to relax the entire floor of the oral cavity, it is preferable to press the floor of the oral cavity at a plurality of points. The pressing on the floor of the oral cavity is preferably performed such that, among the plurality of points on the floor of the oral cavity, points on the front side of the floor of the oral cavity are pressed first and thereafter points on the back side (deeper side) of the floor of the oral cavity are pressed. Since the back side of the oral cavity may be sensitive, it is preferable to gradually shift the points to be pressed, from the front side to the back side. After the pressing on the points on the back side of the floor of the oral cavity is done, the points on the front side of the floor of the oral cavity may be pressed again. The front-to-back shifting of the points to be pressed may be repeatedly performed. The pressing is preferably performed on both the left side and the right side of the floor of the oral cavity.

The downward pressing on the floor of the oral cavity is preferably performed on at least either of the mylohyoid muscle and the geniohyoid muscle, and more preferably performed on the mylohyoid muscle. The mylohyoid muscle and the geniohyoid muscle are muscles that can be easily accessed from the inside of the oral cavity, and therefore are suitable targets for downward pressing.

The second process may include, as an access to the base of the tongue, at least one of: a 2-1 process of raising the base of the tongue by using the insertion body inserted between the bottom of the tongue and the floor of the oral cavity; and a 2-2 process of moving the tongue forward such that the back side of the floor of the oral cavity presses the insertion body forward, with the insertion body being kept in place between the bottom of the tongue and the floor of the oral cavity.

In the 2-1 process, the base of the tongue is forcibly raised with respect to the floor of the oral cavity by the insertion body. The raising of the base of the tongue acts as a stimulus to or stretching of the base of the tongue, thereby relaxing the base of the tongue.

The insertion body may be inserted between the bottom of the tongue and the floor of the oral cavity from the left side of the tongue, for example. In this state, by tilting the insertion body upward to the right, the base of the tongue is raised from the left side of the tongue. In this case, the base of the tongue is raised such that the left side of the tongue is higher than the right side thereof.

Also, the insertion body may be inserted between the bottom of the tongue and the floor of the oral cavity from the right side of the tongue. In this state, by tilting the insertion body upward to the left, the base of the tongue is raised from the right side of the tongue. In this case, the base of the tongue is raised such that the right side of the tongue is higher than the left side thereof.

Raising of the base of the tongue may be performed only from either of the left and right sides. However, the entire base of the tongue can be relaxed by raising the base of the tongue from both the left and right sides. The insertion body may be inserted from the front of the tongue.

The insertion body used for raising the base of the tongue may be the same as the pressing body used for pressing in the first process.

In the 2 -2 process, the base of the tongue is stretched by moving the tongue forward. That is, when a person autonomously moves his/her tongue forward while the tongue is inhibited from moving forward by the insertion body inserted between the bottom of the tongue and the floor of the oral cavity, the tongue will try to move forward while the base of the tongue presses the insertion body forward. That is, with the forward movement of the tongue, the insertion body that remains between the bottom of the tongue and the floor of the oral cavity presses the base of the tongue backward. Thus, the base of the tongue is stretched, and relaxed. Furthermore, by moving the tongue forward, the palatoglossal arch connected to the base of the tongue is also stretched, and relaxed. The 2 -2 process is suitable for relaxing the palatoglossal arch.

The second process preferably includes both the 2-1 process and the 2-2 process. The order of the 2-1 process and the 2-2 process is not particularly limited. The 2-1 process may be performed first, followed by the 2-2 process. The 2-2 process may be performed first, followed by the 2-1 process. However, it is more preferable to perform the 2-1 process first, and the 2-2 process later. The base of the tongue is relaxed in the 2-1 process, and the tongue whose base is relaxed is moved forward, whereby the palatoglossal arch connected to the base of the tongue can be more effectively relaxed.

The order of the first process and the second process is not particularly limited. The first process may be performed first, followed by the second process. The second process may be performed first, followed by the first process. However, it is more preferable to perform the first process first, and the second process later. By performing the first process first while avoiding the second process, in which the sensitive area near the base of the tongue is accessed, from being performed first, the floor of the oral cavity including the area near the base of the tongue can be gradually acclimated to stimulation. By performing the second process after the area near the base of the tongue is acclimated to stimulation, the second process can be smoothly performed.

### <2. Example of Vocalization Conditioning and Vocal Training Method by Accessing Oral Cavity>

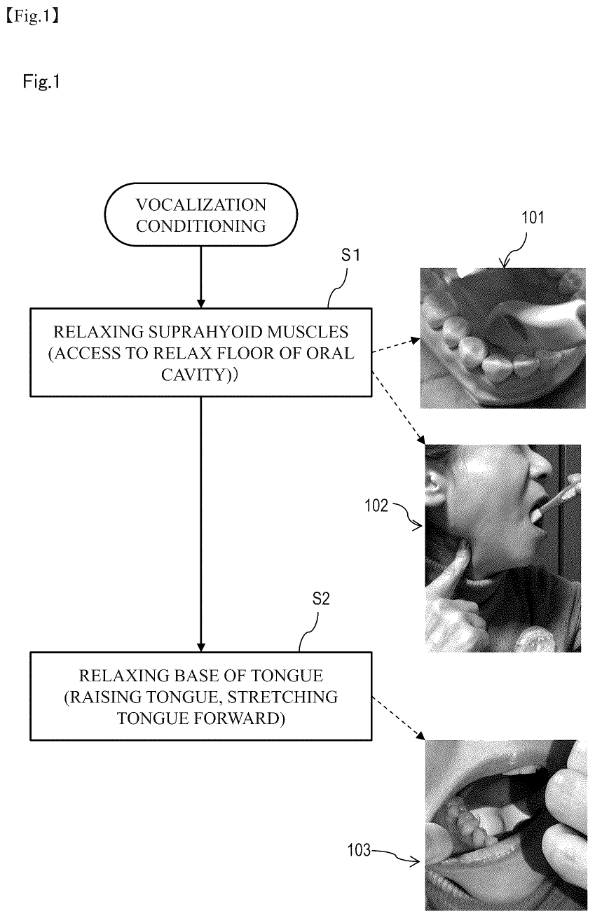

Hereinafter, an example of an embodiment of the present invention will be described with reference to the drawings. FIG. 1 shows an example of a procedure of vocalization conditioning according to the embodiment. The vocalization conditioning of the embodiment is performed by accessing an oral cavity. In step S1 in FIG. 1, suprahyoid muscles are relaxed from the inside of the oral cavity of a speaker (see images 101, 102). Step S1 is a first process of accessing the floor of the oral cavity. Thereafter, in step S2, the base of a tongue is relaxed (see image 103). Step S2 is a second process of accessing the base of the tongue.

Through steps S1 and S2, the suprahyoid muscles and the base of the tongue are relaxed to improve the vocalization condition. Therefore, improved vocalization can be achieved by vocalizing after step S1 and step S2. For example, in voice training, performing step S1 and step S2 before vocalization allows the speaker to perform better vocalization, and improves the efficiency of the training. Step S1 and step S2 may be performed by the speaker using a technique of accessing the inside of his/her oral cavity, or may be performed by a person who supports conditioning, using a technique of accessing the inside of the speaker's oral cavity.

The speaker is, for example, a person whose job specializes in using his/her voice. Examples of a person whose job specializes in using his/her voice include a vocalist, a singer, a voice actor, an announcer, a narrator, and a master of ceremonies. A person who supports conditioning is, for example, a voice coach.

In step S1 and step S2, as a tool for accessing the inside of the oral cavity (oral cavity pressing tool), a tool (product name: Stretch Oral (registered trademark), manufactured by Forest Co., Ltd.) described in PATENT LITERATURE 1 can be used. This tool has a head provided at its front end, and has a handle extending backward from the head. In step S1, this tool is used as an oral cavity pressing tool that presses the floor of the oral cavity with the head. In step S2, this tool is used as an insertion body that is inserted between the bottom of the tongue and the floor of the oral cavity. In step S2, the head of the oral cavity pressing tool presses the base of the tongue.

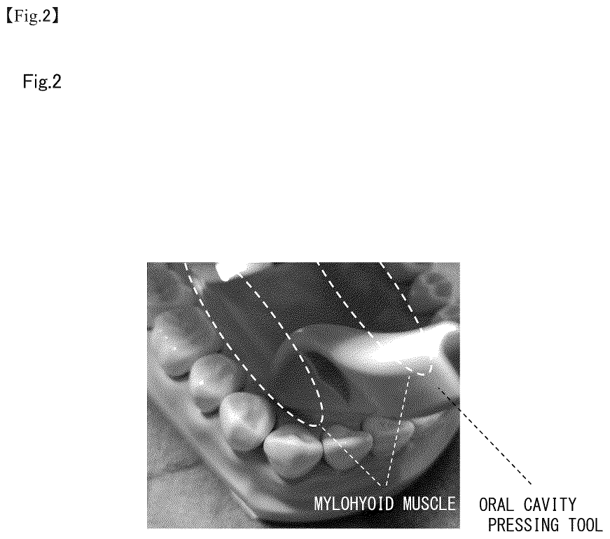

In step S1, the mylohyoid muscle shown in FIG. 2 is pressed by the front end (head) of the oral cavity pressing tool inserted into the oral cavity. The oral cavity pressing tool is inserted into the oral cavity with the handle being kept upright as much as possible with respect to the bone surface of the mandible (the floor of the oral cavity).

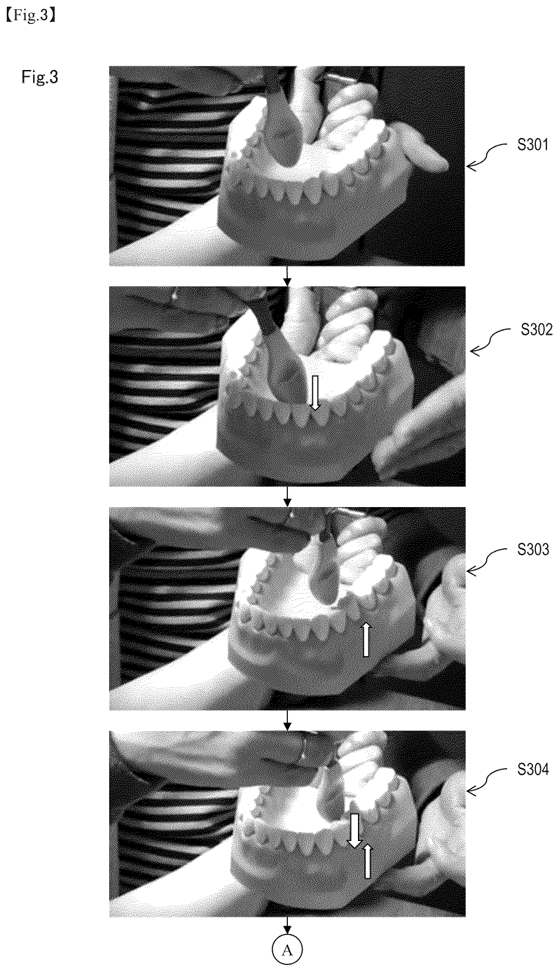

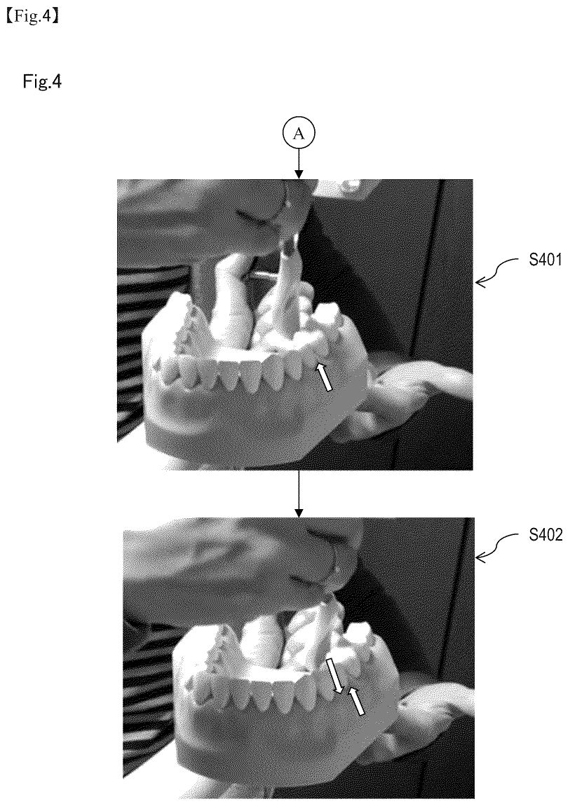

FIG. 3 and FIG. 4 show the flow of an operation of the oral cavity pressing tool in step S1. Firstly, the oral cavity pressing tool is inserted into the front side of the floor of the oral cavity (near the back side of the lower front teeth) while avoiding the tongue (step S301 in FIG. 3), and presses the front side of the floor of the oral cavity (step S302). In order to repeatedly perform the pressing, the oral cavity pressing tool being kept upright is moved up and down within the oral cavity while being moved backward along the mylohyoid muscle (steps S303, S304, S401, S402). Thus, the mylohyoid muscle is repeatedly pressed from the front side to the back side (deep side). As a result, the range from the front side to the back side of the mylohyoid muscle is stimulated by compression due to the pressing and release of the compression (or reduction in the compression), and is relaxed.

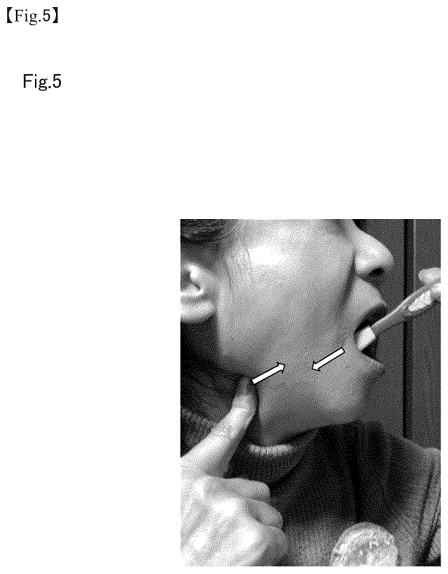

As shown in the images of steps S303, S304, S401, S402, the lower side of the mandible (the lower side of the jaw) is pressed upward with a finger or the like from the outside of the oral cavity while the floor of the oral cavity is pressed downward, whereby stimulation by the downward pressing is effectively applied to the floor of the oral cavity. In order to efficiently apply the stimulation, it is preferable that the spot of the upward pressing from the lower side of the mandible is near an extended position in the downward pressing direction as shown in FIG. 5. It is preferable that the upward pressing from the lower side of the mandible is shifted from the front side to the back side of the floor of the oral cavity as the downward pressing on the floor of the oral cavity is shifted from the front side to the back side of the floor of the oral cavity.

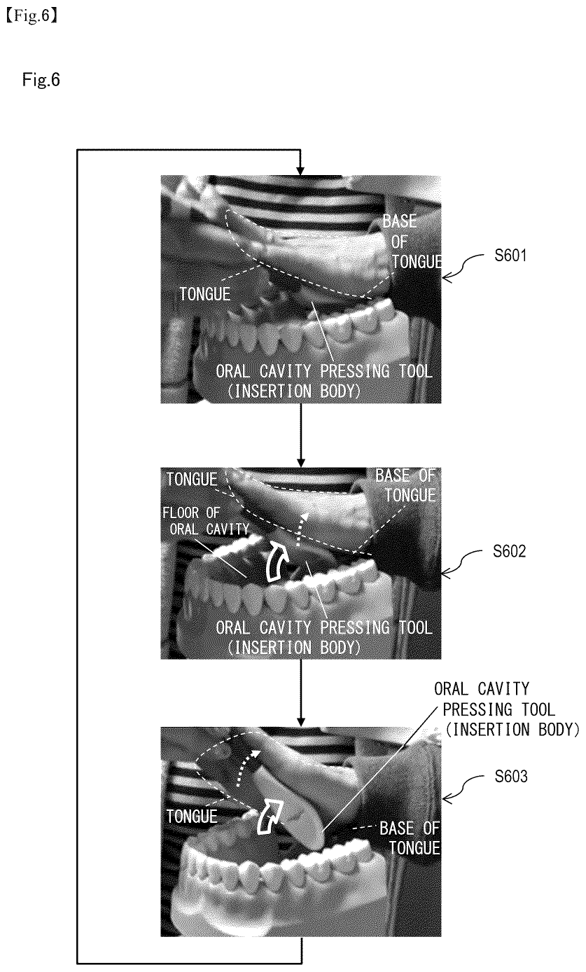

In step S1, the oral cavity pressing tool is moved to the back side while pressing the floor of the oral cavity (from step S301 to step S402), and when the oral cavity pressing tool reaches the innermost part of the floor of the oral cavity, the head of the oral cavity pressing tool (insertion body) is inserted between the bottom of the tongue and the floor of the oral cavity as shown in FIG. 6 (step S601).

In FIG. 6, since a model without a tongue is used, the left hand of an operator holding the oral cavity pressing tool (insertion body) in his/her right hand is shown as a “tongue”. In FIG. 6, a range corresponding to the “tongue” is indicated by a white dotted line. In FIG. 6, the wrist and its vicinity of the left hand imitating the “tongue” correspond to the position of the “base of the tongue”, and the palm of the left hand imitating the “tongue” corresponds to the bottom of the tongue. FIG. 6 shows the state in which the oral cavity pressing tool is inserted between the bottom of the tongue and the floor of the oral cavity, from the left side of the tongue.

From the state of step S601, the handle of the oral cavity pressing tool is tilted upward slightly to the right as shown in steps S602, S603, whereby the base of the tongue is raised from the left side of the tongue (step S2 in FIG. 1: 2-1 process). By repeating the operation of moving the handle of the oral cavity pressing tool up and down, the base of the tongue can be raised multiple times. The base of the tongue can be further relaxed by being raised multiple times.

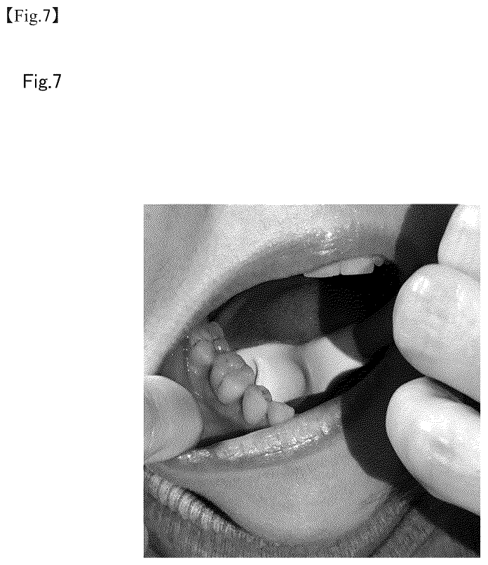

FIG. 7 shows the state in which the base of the tongue is actually raised. In FIG. 7, the oral cavity pressing tool is inserted between the bottom of the tongue and the floor of the oral cavity from the right side of the tongue, and the handle of the oral cavity pressing tool is tilted upward. In FIG. 7, the base of the tongue is raised from the right side of the tongue.

After the base of the tongue has been raised through steps S601 to S603, the oral cavity pressing tool is returned to the state of step S601. That is, the oral cavity pressing tool is returned to the state in which the base of the tongue is not raised, and the oral cavity pressing tool is inserted between the bottom of the tongue and the floor of the oral cavity.

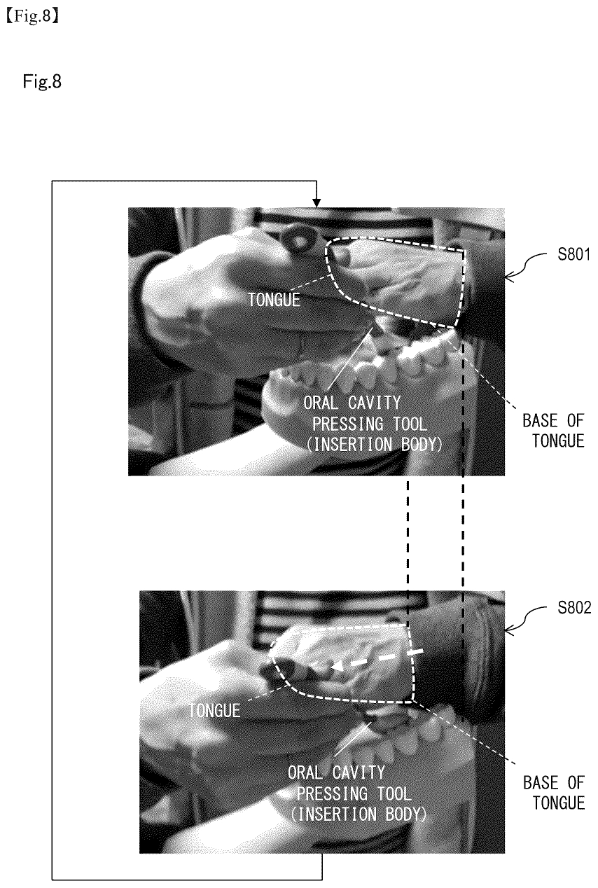

Step S801 in FIG. 8 shows the state returned to S601 in FIG. 6. In FIG. 8 as well, the left hand of the operator holding the oral cavity pressing tool (insertion body) in his/her right hand is shown as a “tongue”.

In step S801 in FIG. 8, the oral cavity pressing tool (insertion body) is in the state of being inserted between the bottom of the tongue and the floor of the oral cavity. In this state, the oral cavity pressing tool is kept in place without being moved, and the person to be subjected to conditioning autonomously moves the tongue forward (step S802).

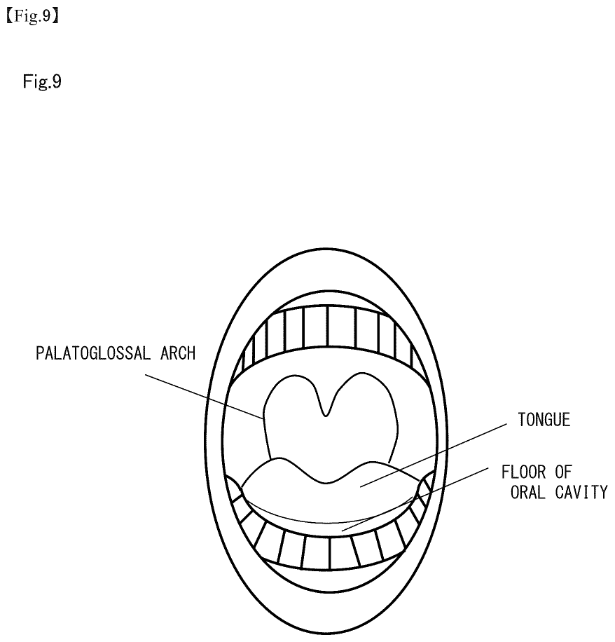

As shown in FIG. 8, when the tongue is moved forward in the oral cavity while the tongue is inhibited from moving forward by the oral cavity pressing tool, the base of the tongue presses the insertion body forward. As a result, the base of the tongue is stretched and relaxed, and a palatoglossal arch (see FIG. 9) connected to the base of the tongue is also stretched, and is surely relaxed (step S2 in FIG. 1: 2-2 process). By repeating the back-and-forth reciprocation of the tongue multiple times, the base of the tongue and the palatoglossal arch are more effectively stretched.

When the tongue is moved forward in both the state where the oral cavity pressing tool (insertion body) is inserted from the left side of the tongue and the state where it is inserted from the right side of the tongue, the entire tongue base and palatoglossal arch are stretched more effectively.

### <3. Experiments>

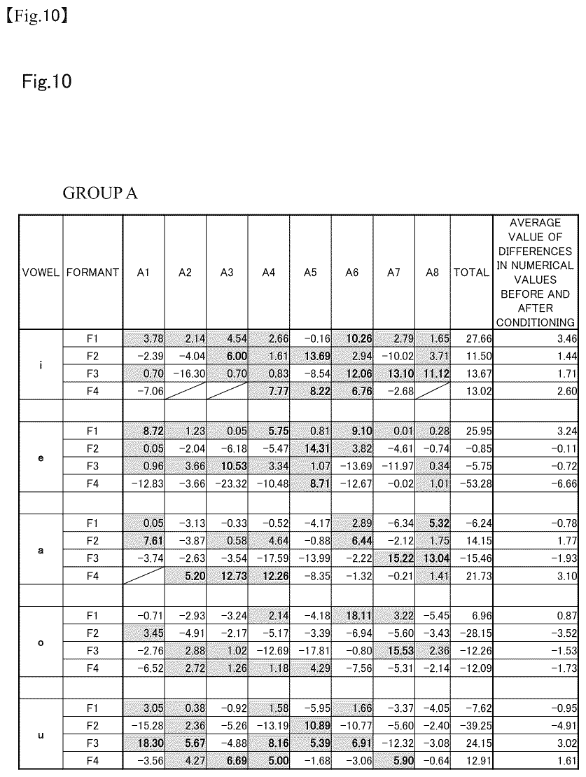

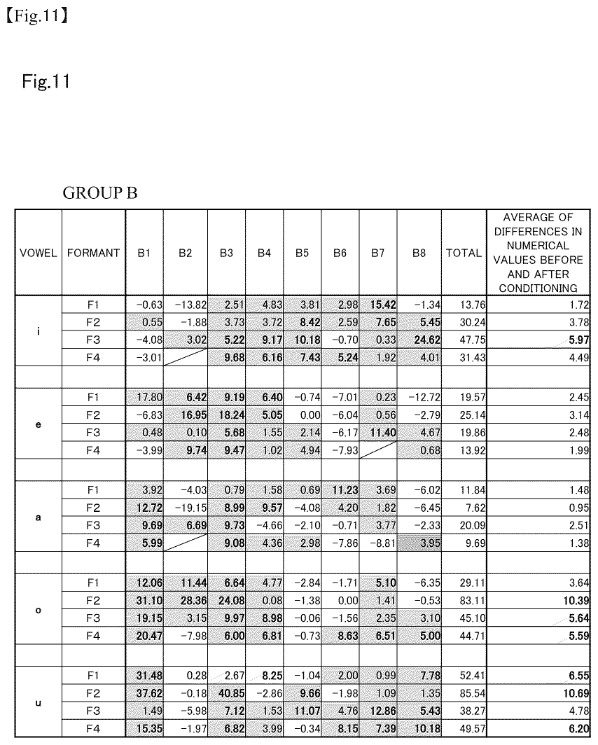

FIG. 10 and FIG. 11 show the results of conditioning experiments. In the experiments, before and after a first group (hereinafter referred to as “group A”) and a second group (hereinafter referred to as “group B”) were subjected to oral cavity conditioning, subjects in each group were instructed to vocalize, vocalization voices were recorded, and the recorded voices were analyzed.

The group A consisted of eight subjects A1, A2, A3, A4, A5, A6, A7, A8, and the group B consisted of eight subjects B1, B2, B3, B4, B5, B6, B7, B8. The subjects in the group A and group B were students of a music department.

The oral cavity conditioning for the group A and the group B was performed using the tool (product name: Stretch Oral (registered trademark), manufactured by Forest Co., Ltd.) described in PATENT LITERATURE 1.

The oral cavity conditioning method for the subjects in the group A was “access to a tongue”. The method for “access to a tongue” was based on “oral stretch method” described in “Kuchi no naka kara yomigaere! (provisional translation: Get healthy from the inside of your mouth!)”, written by Akira MORI, published by Nihonbashi Publishing Company, 2021. This book introduces an oral care method using “Stretch Oral (registered trademark)”. In the “access to a tongue”, a tongue is stimulated and stretched using “Stretch Oral (registered trademark)”.

This book discloses oral cavity conditioning that accesses a tongue, but does not disclose a vocalization conditioning method.

The oral cavity conditioning method for the subjects in the group B was “access to the floor of the oral cavity and the base of the tongue”. The method for “access to the floor of the oral cavity and the base of the tongue” was similar to the method described with reference to FIG. 1 to FIG. 8. That is, the conditioning method for the group B includes the first process of accessing the floor of the oral cavity, and the second process of accessing the base of the tongue. The first process includes repeating downward pressing on the floor of the oral cavity inside the oral cavity to repeatedly cause compression and release of compression with respect to the muscles included in the suprahyoid muscles. The second process includes both the 2-1 process of raising the base of the tongue with respect to the floor of the oral cavity by using the insertion body inserted between the bottom of the tongue and the floor of the oral cavity, and the 2-2 process of moving the tongue forward such that the base of the tongue presses the insertion body forward, with the insertion body inserted between the bottom of the tongue and the floor of the oral cavity.

Before initiating oral cavity conditioning on the subjects, each subject was instructed to pronounce vowels “i, e, a, o, u” three times with BMP60, and the voice of each subject was recorded. The pitch of the pronunciation was not instructed. Each subject was instructed to continuously pronounce the vowels without any pause.

Thereafter, each subject was subjected to the aforementioned oral cavity conditioning.

After the oral cavity conditioning, each subject was instructed to perform the pronunciation, and the voice was recorded. The pronunciation was the same as the pronunciation method used before the oral cavity conditioning. The pronunciation was performed within 10 minutes after completion of the oral cavity conditioning.

Then, the recorded voices were subjected to acoustic analysis. The acoustic analysis was performed by formant analysis. In the formant analysis, an amplitude [dB] at each formant frequency was obtained, and the numerical values of amplitudes [dB] of each formant before and after the conditioning were compared. The formants are referred to as first formant F1, second formant F2, third formant F3, and fourth formant F4 in ascending order of frequency.

FIG. 10 shows differences [dB] in numerical values of amplitudes [dB] of the respective formants before and after the conditioning, regarding the vowels “i, e, a, o, u” that each of the subjects (A1, A2, A3, A4, A5, A6, A7, A8) in the group A pronounced. For example, differences between the formants F1, F2, F3, F4 before the conditioning and those after the conditioning, when the subject Al pronounced the vowel “i”, are “3.78”, “−2.39”, “0.70”, “−7.06”, respectively. The difference “3.78” indicates that the value [dB] after the conditioning is about 3.78 [dB] greater than the value [dB] before the conditioning. The difference “−2.39” indicates that the value [dB] after the conditioning is about 2.39 [dB] smaller than the value [dB] before the conditioning. The difference “0.70” indicates that the value [dB] after the conditioning is about 0.70 [dB] greater than the value [dB] before the conditioning. The difference “−7.06” indicates that the value [dB] after the conditioning is about 7.06 [dB] smaller than the value [dB] before the conditioning.

In the table shown in FIG. 10, columns in which the value [dB] after the conditioning is smaller than the value [dB] before the conditioning are shown in white.

Columns in which the value [dB] after the conditioning is greater than the value [dB] before the conditioning are shown in gray. In columns in which the value [dB] after the conditioning is 5.0 [dB] or more greater than the value [dB] before the conditioning, the numerical values are shown in bold. An increase of 6 [dB] doubles the loudness of sound. Therefore, it can be said that an increase of 5.0 [dB] or more causes the loudness of sound to be substantially twice as loud.

FIG. 11 shows differences [dB] in numerical values of amplitudes [dB] of the respective formants before and after the conditioning, regarding the vowels “i, e, a, o, u” that each of the subjects (B1, B2, B3, B4, B5, B6, B7, B8) in the group B pronounced. The table shown in FIG. 11 is formed similarly to the table shown in FIG. 10.

With reference to FIG. 10, in the group A, there are some “gray” columns indicating that the voice has become louder after the conditioning, and there are “white” columns, indicating that the voice has become softer after the conditioning, substantially equal in number to the “gray” columns. In FIG. 10, there are not many formants in which the voice has become louder by 5.0 [dB] or more after the conditioning.

In FIG. 10, taking a look at an average value [dB], for each formant, of the differences in the numerical values before and after the conditioning, the average values are small as a whole, and are distributed within a range of small values centering around 0. There is no formant in which the voice has become louder by 5.0 [dB] or more after the conditioning, but there are many formants in which the voice has become softer after the conditioning.

Accordingly, in the group A, even if there are cases where the voice has become louder after the conditioning, there are also instances where the voice has become softer after the conditioning, substantially equal in number to the aforementioned cases. Therefore, it is understood that the increase/decrease in the loudness of the voice before and after the conditioning was simply caused by variation in pronunciation before and after the conditioning. Therefore, in the group A, there is little or no improvement in vocalization due to the conditioning. Consequently, the oral cavity conditioning performed on the group A has little or no effect from vocalization conditioning.

On the other hand, referring to FIG. 11, in the group B, the number of “gray” columns indicating that the voice has become louder after the conditioning is sufficiently greater than the number of “white” columns indicating that the voice has become softer after the conditioning. In addition, the number of formants in which the voice has become louder by 5.0 [dB] or more after the conditioning is greater than that in FIG. 10.

In FIG. 11, taking a look at an average value [dB], for each formant, of the differences in the numerical values before and after the conditioning, the average values are large as a whole, there are formants in which the voice has become louder by 5.0 [dB] or more after the conditioning, and there is no formant in which the voice has become softer after the conditioning. Therefore, in the group B, improvement in vocalization due to the conditioning is recognized. Consequently, it is found that the oral cavity conditioning performed on the group B has an effect from vocalization conditioning.

In the group B, an increase in loudness of voice due to the conditioning is relatively large for the vowels “i, o, u”, and particularly large for the vowels “o, u”. On the other hand, the vowel “e” has a slightly smaller increase in loudness of voice, and the vowel “a” has the smallest increase. The reason that improvement in pronunciation after the conditioning differs among the vowels is considered to be related to the conditioning method applied to the group B.

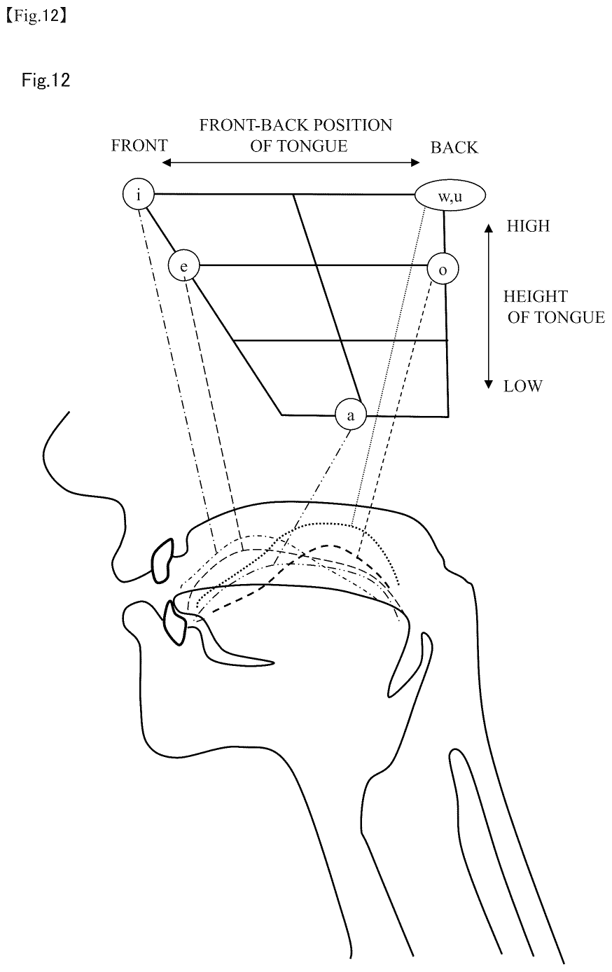

That is, as shown in FIG. 12, the vowels “o, u” are pronounced with the “back side” of the tongue being raised high. The vowel “i” is pronounced with the “front side” of the tongue being raised high. The vowel “e” is pronounced with the “front side” of the tongue being raised, but the tongue may be lower than that for the vowel “i”. The vowel “a” does not need as much raising of the tongue.

Regarding the group B, relaxing of the floor of the oral cavity and the base of the tongue allows the tongue to be easily raised, and widens the airway. Therefore, it is considered that the loudness of the voice for the vowels “i, o, u”, which require raising of the front side or the back side of the tongue, has been significantly improved. In addition, the base of the tongue being the back side of the tongue is relaxed. Therefore, it is considered that the loudness of the voice for the vowels “o, u”, which require the back side of the tongue to be raised high, is significantly improved in particular. In this way, relaxing the floor of the oral cavity and the base of the tongue significantly improves vocalization for the vowels “i, o, u”, and in particular, significantly improves vocalization for the vowels “o, u”.

### <4. Additional Note>

The present invention is not limited to the above embodiment, and various modifications thereof can be made.

### INDUSTRIAL APPLICABILITY

People who make a living using their voices, such as a vocalist, a singer, a voice actor, an announcer, a narrator, and a master of ceremony, can use the vocalization conditioning method and the vocal training method according to the present invention to professionally improve their vocalization conditions. Furthermore, people who support vocalization conditioning, such as a voice coach, can use the vocalization conditioning method and the vocal training method to professionally subject speakers to vocalization training.

1. A vocalization conditioning method by accessing an oral cavity, comprising:
a first process of stimulating a floor of the oral cavity to relax muscles included in suprahyoid muscles from the inside of the oral cavity; and
a second process of accessing a base of a tongue by using an insertion body that is inserted between a bottom of the tongue and the floor of the oral cavity, and relaxing the base of the tongue from the inside of the oral cavity.

2. A vocalization conditioning method by accessing an oral cavity, comprising:
a first process of accessing a floor of the oral cavity; and
a second process of accessing a base of a tongue, wherein
the first process includes repeating downward pressing on the floor of the oral cavity inside the oral cavity to repeatedly cause compression and release of compression with respect to muscles included in suprahyoid muscles, and
the second process includes at least one of:
a 2-1 process of raising the base of the tongue with respect to the floor of the oral cavity by using an insertion body inserted between a bottom of the tongue and the floor of the oral cavity; and
a 2-2 process of moving the tongue forward such that the base of the tongue presses the insertion body forward, with the insertion body inserted between the bottom of the tongue and the floor of the oral cavity.

3. The vocalization conditioning method according to claim 2,
wherein
in the first process, repeating the downward pressing on the floor of the oral cavity includes downward pressing each of a plurality of points from a front side to a back side of the floor of the oral cavity, and
the second process is performed after the first process.

4. The vocalization conditioning method according to claim 2,
wherein
the muscles included in the suprahyoid muscles include at least a mylohyoid muscle.

5. A vocal training method comprising:
performing the vocalization conditioning method according to claim 1; and
performing vocalization thereafter.

6. A vocal training method comprising:
performing the vocalization conditioning method according to claim 2; and
performing vocalization thereafter.
